(19) United States
(12) Patent Application Publication
(10) Pub. No.: US 2014/0219122 A1
(43) Pub. Date: Aug. 7, 2014

(54) CONTROL APPARATUS, REPRESENTATIVE BASE STATION AND BASE STATION CONTROL METHOD

(71) Applicant: KABUSHIKI KAISHA TOSHIBA, Minato-ku (JP)

(72) Inventors: Kohta NAKAMURA, Fuchu-shi (JP); Keiji YAMAMOTO, Ome-shi (JP); Taichi TASHIRO, Fuchu-shi (JP); Kazuya NEGISHI, Saitama-shi (JP)

(73) Assignee: KABUSHIKI KAISHA TOSHIBA, Minato-ku (JP)

(21) Appl. No.: 14/164,381

(22) Filed: Jan. 27, 2014

(30) Foreign Application Priority Data
Feb. 6, 2013 (JP) 2013-021379

(51) Int. Cl. H04W 24/10

(52) U.S. Cl. CPC H04W 24/10
USPC 370/252

(57) ABSTRACT

According to one embodiment, a control apparatus includes a terminal information collecting unit, an area determining unit, a parameter calculator, and a parameter setting unit. The terminal information collecting unit calculates an SINR based on reception powers and physical cell IDs. The area determining unit determines a low-throughput area in reference to at least one of the SINRs and reception powers. The parameter calculator selects a base station that causes the low-throughput area and calculates an operation frequency and transmission power of the selected base station. The parameter setting unit sets the calculated operation frequency and transmission power with respect to the selected base station.

### CROSS-REFERENCE TO RELATED APPLICATIONS

This application is based upon and claims the benefit of priority from prior Japanese Patent Application No. 2013-021379, filed Feb. 6, 2013, the entire contents of which are incorporated herein by reference.

### FIELD

Embodiments described herein relate generally to a control apparatus, representative base station and base station control method.

### BACKGROUND

As cellphone traffic increases year by year, it is required to further enhance the speed of mobile communications, which is why communication companies have started a service called Long Term Evolution (LTE), intended to speed up radio communications. Further, indoor cellphone traffic increases year by year, necessitating the quality of radio communications to be enhanced to further expand cellphone data traffic.

In order to enhance the indoor traffic capacity, it is necessary to arrange a large number of base stations called femtocells, which have a near-field range of several ten meters. If the base stations with the same operation frequency are arrange adjacent to each other, interference occurs and the throughput is lowered. It is thus required to suppress the interference by eliminating the indoor dead zone (outside the phone service) by adjusting the transmission power of femtocells and assigning the operation frequencies so as not to overlap the same operation frequency, and enhance the throughput to enhance the quality of indoor radio communications traffic.

Conventionally, it is requested for a design contractor to make calculations of parameters assigned to the respective base stations and the thus obtained parameters are manually configured in the respective base stations. However, with such manual setting, the cost for initial setting, maintenance and the like increases. Further, since the radio wave environment varies according to the indoor environment, optimum traffic cannot be maintained in some cases since in the previous system the parameters were fixed at the initial setting time by previously grasping the radio wave environment by use of a measurement terminal, which then automatically configured optimum parameters. Under such conditions, if an attempt is made to dynamically adjust the parameters, it becomes necessary to measure the radio wave environment again by use of the measurement terminal during the operation.

### BRIEF DESCRIPTION OF THE DRAWINGS

FIG. 1 is a block diagram showing the functional configuration of a radio communication system according to a first embodiment.

FIG. 2 is a block diagram showing the functional configuration of a base station and communication terminal shown in FIG. 1.

FIG. 3 is a block diagram showing the functional configuration of a control apparatus shown in FIG. 1.

FIG. 4 is a sequence diagram showing a case wherein the radio communication system shown in FIG. 1 sets a parameter in the base station.

FIG. 5 is a diagram showing an example of a correspondence table transmitted from the communication terminal shown in FIG. 1 to the base station.

FIG. 6 is a diagram showing an example of correspondence tables of the communication terminals, base stations and control apparatus shown in FIG. 1.

FIG. 7 is a diagram showing an example of the state obtained before the control apparatus shown in FIG. 1 adjusts the base station.

FIG. 8 is a diagram showing an example of the state obtained after the control apparatus shown in FIG. 1 adjusted the base station.

FIG. 9 is a block diagram showing the functional configuration of a radio communication system according to a second embodiment.

FIG. 10 is a block diagram showing the functional configuration of a representative base station and communication terminal shown in FIG. 9.

FIG. 11 is a sequence diagram showing a case wherein the radio communication system shown in FIG. 9 sets parameters of the representative base station and base station.

FIG. 12 is a diagram showing an example of correspondence tables of the communication terminals, representative base station and base stations shown in FIG. 9.

### DETAILED DESCRIPTION

In general, according to one embodiment, a control apparatus includes a terminal information collecting unit, an area determining unit, a parameter calculator, and a parameter setting unit. The terminal information collecting unit acquires reception powers and physical cell IDs from a plurality of base stations, calculates a Signal to Interference and Noise power Ratio (SINR) for each of a plurality of communication terminals that make radio communications with the plural base stations based on the acquired reception powers and physical cell IDs, and collects the acquired reception powers and physical cell IDs. The reception powers are transmitted to a base station from a communication terminal communicating each other which receives signals transmitted from the plural base stations. The physical cell IDs are transmitted to a base station from a communication terminal communicating each other. The physical cell IDs are specifying base stations transmitting the signal. The area determining unit determines a low-throughput area in which sufficient throughput is not obtained in reference to at least one of the SINRs and reception powers. The parameter calculator selects a base station that causes the low-throughput area and calculates an operation frequency and transmission power of the selected base station to enhance the throughput of the low-throughput area. The parameter setting unit sets the calculated operation frequency and transmission power with respect to the selected base station.

### First Embodiment

Next, embodiments are explained with reference to the drawings.

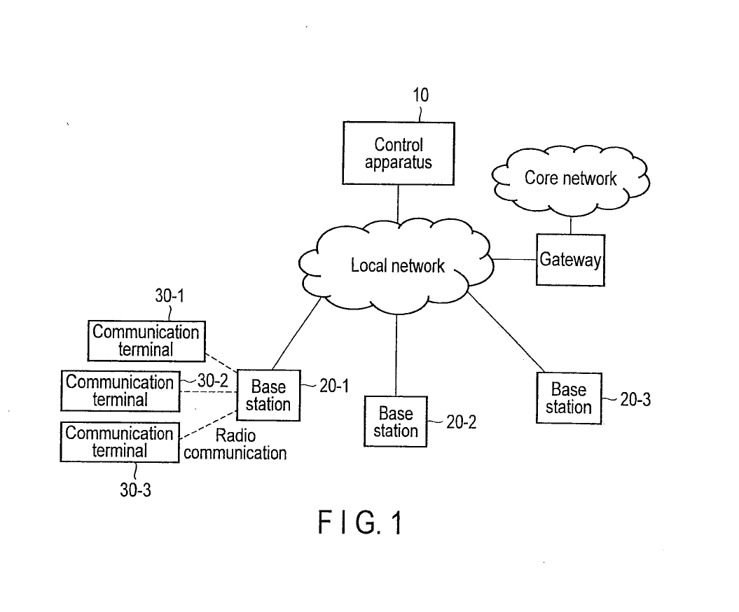

FIG. 1 is a block diagram showing the functional configuration of a radio communication system according to a first embodiment. The radio communication system shown in FIG. 1 includes a control apparatus 10 and base stations 20-1 to 20-3. The control apparatus 10 and the base stations 20-1 to 20-3 are connected via a local network. Referring to FIG. 1, the base station 20-1 accommodates communication terminals 30-1 to 30-3 for radio communicating with it. Although not shown in FIG. 1, each of the base stations 20-2, 20-3 accommodates communication terminals for radio communication with it. The local network is connected to a core network (commercial network) via a gateway.

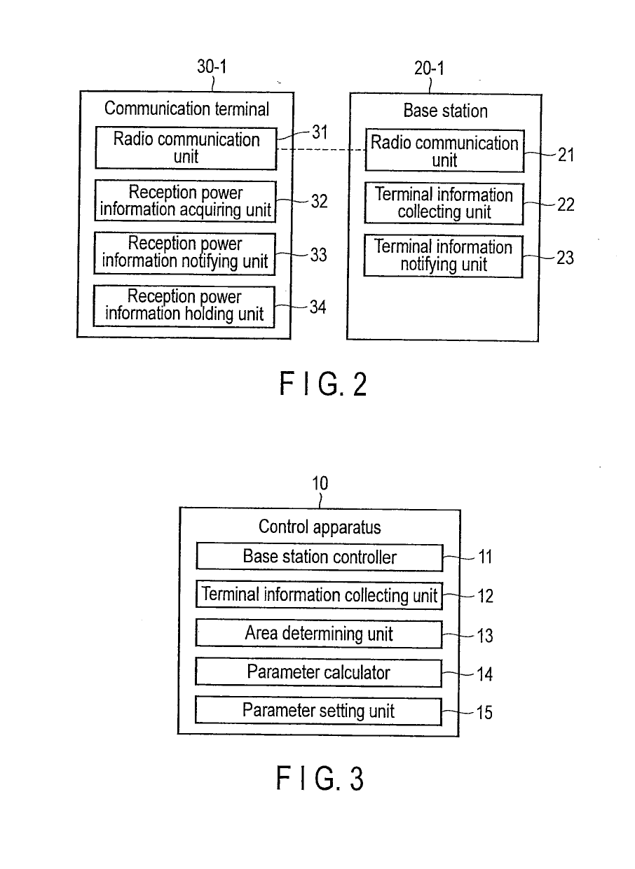

FIG. 2 is a block diagram showing the functional configuration of the base station 20-1 and communication terminal 30-1 shown in FIG. 1. In FIG. 2, the functional configuration of the communication terminal 30-1 and base station 20-1 is shown as an example. The configurations of the communication terminal 30-1 and base station 20-1 are same with the communication terminals 30-2, 30-3 and base stations 20-2, 20-3, respectively. The communication terminal 30-1 shown in FIG. 2 includes a radio communication unit 31, reception power information acquiring unit 32, reception power information holding unit 33, and reception power information notifying unit 34.

The radio communication unit 31 makes radio communication with, for example, the base station 20-1 having the highest reception power of a signal to be transmitted among the base stations 20-1 to 20-3 according to an LTE protocol.

The reception power information acquiring unit 32 acquires a reception power of a signal transmitted from the base stations 20-1 to 20-3 and a physical cell ID used for specifying the base station that has transmitted the signal on a preset cycle. The reception power and physical cell ID can be acquired according to an LTE standard specification.

The reception power information holding unit 33 forms a correspondence table of the acquired reception power and physical cell ID, and holds the correspondence table. The reception power information holding unit 33 updates the correspondence table each time the reception power information acquiring unit 32 acquires a new reception power and physical cell ID.

The reception power information notifying unit 34 transmits the correspondence table as terminal information to the base station 20-1 according to a request from the base station 20-1 connected thereto. At this time, the reception power information notifying unit 34 adds an identifier of its own terminal to terminal information and transmits terminal information added the identifier to the base station 20-1. The reception power information notifying unit 34 may actively transmit terminal information to the base station 20-1 at a preset timing.

The base station 20-1 shown in FIG. 2 includes a radio communication unit 21, terminal information collection unit 22, and terminal information notifying unit 23.

The radio communication unit 21 makes radio communications with the communication terminals 30-1 to 30-3. Further, the radio communication unit 21 monitors a handover of switching a connection to another base station by means of the communication terminals 30-1 to 30-3. The radio communication unit 21 forms a handover history indicating whether the communication terminals 30-1 to 30-3 succeeded or failed in making the handover.

The terminal information collecting unit 22 receives terminal information transmitted from the communication terminals 30-1 to 30-3 and collects the received terminal information together with an identifier. The terminal information contains the reception power, physical cell ID and handover history. The terminal information collecting unit 22 may request terminal information items with respect to all of the communication terminals 30-1 to 30-3. Further the terminal information collecting unit 22 may request terminal information with respect to only to the communication terminal that is set in a connected state except the idle state. The idle state is a state in which the communication terminal interrupts the communication function when no communications are made for a preset period between the base station and the communication terminal.

The terminal information notifying unit 23 puts the handover history for the communication terminals 30-1 to 30-3 into the collected terminal information and transmits the resultant information to the control apparatus 10 in response to a request from the control apparatus 10. The terminal information notifying unit 23 may transmit the terminal information to the control apparatus 10 at the preset timing.

For example, the control apparatus 10 includes a Central Processing Unit (CPU), a storage area such as a Read Only Memory (ROM) and Random Access Memory (RAM) for programs and data used for permitting the CPU to perform processes and the like. The control apparatus 10 includes a base station controller 11, terminal information collecting unit 12, area determining unit 13, parameter calculator 14 and parameter setting unit 15 shown in FIG. 3 to permit the CPU to execute the programs.

The base station controller 11 controls the operations of the base stations 20-1 to 20-3.

The terminal information collecting unit 12 receives terminal information transmitted from the base stations 20-1 to 20-3. The terminal information collecting unit 12 calculates a Signal to Interference and Noise power Ratio (SINR) for each communication terminal identified by the identifier contained in the received terminal information with reference to the reception power and physical cell ID contained in the received terminal information. The terminal information collecting unit 12 collects terminal information items transmitted from the base stations 20-1 to 20-3. The terminal information collecting unit 12 outputs the calculated SINR and collected terminal information to the area determining unit 13.

The area determining unit 13 determines whether or not an area in which the communication terminal is present is a low-throughput area in which a sufficiently high throughput cannot be ensured with reference to at least one of the SINR, reception power and handover history. The area determining unit 13 outputs the determination result to the parameter calculator 14.

As a system for determining the low-throughput area, for example, the following three systems are given. First, as the first system, if the SINR calculated by the terminal information collecting unit 12 is less than a preset first threshold value (for example, 4 dB), the area determining unit 13 determines that an area in which a communication terminal having the SINR is present is a low-throughput area. As a result, for example, the area determining unit 13 can determine an area in which interference occurs because signals of the same frequency are transmitted from the adjacent base stations. The parameter calculator 14 that will be described later can specify base stations that transmit the signals causing the interference to determine the frequencies and transmission powers of the signals transmitted from the base stations.

Next, as the second system, if the maximum value of the reception power is less than a preset second threshold value in the respective communication terminals 30-1 to 30-3, the area determining unit 13 determines that an area in which a communication terminal having the maximum value is present is a low-throughput area. As a result, for example, the area determining unit 13 can determine an area in which the reception power is weak. The parameter calculator 14 can specify a base station whose transmission power is weak to calculate transmission power optimum for the base station.

Next, as the third system, if a communication terminal that has failed in making a handover a preset number of times or more in the preset closest period is present with reference to the handover history, the area determining unit 13 determines that an area in which the communication terminal is present is a low-throughput area. Further, if a communication terminal that keeps failing to make a handover in the preset closest period is present with reference to the handover history, the area determining unit 13 determines that an area in which the communication terminal is present is a low-throughput area. As a result, for example, the area determining unit 13 can determine an area that is set as a dead zone (outside the phone service). The parameter calculator 14 can specify a base station that causes the dead zone to calculate the transmission power optimum for the base station.

The parameter calculator 14 determines the transmission power, operation frequency, physical cell ID, neighbor list, handover threshold value, base station ID, frequency bandwidth, IP address of a base station, adjacent cell information, cell size and the like with reference to the determination result output from the area determining unit 13 to enhance the throughput in the low-throughput area. The neighbor list, adjacent cell information and handover threshold value can be combined with the transmission power and operation frequency to create an optimum radio wave environment. That is, if a frequency resource with respect to the communication terminal in the operation is assigned again by intentionally changing the neighbor list and adjacent cell information during the operation, the handover can be controlled to create an optimum radio wave environment. Further, if a handover threshold value obtained after changing is used as the handover threshold value, the throughput in the low-throughput area can be enhanced by changing the connection destination of the terminal.

Specifically, for example, the parameter calculator 14 refers to the determination result to select at least one of the base stations 20-1 to 20-3 as a base station that causes a low-throughput area. The parameter calculator 14 calculates the transmission power and operation frequency with respect to the selected base station to enhance the throughput in the low-throughput area. The parameter calculator 14 outputs the physical cell ID of the selected base station and the calculated transmission power and operation frequency to the parameter setting unit 15.

The parameter setting unit 15 sets the determined parameter in the base station specified by the physical cell ID output from the parameter calculator 14.

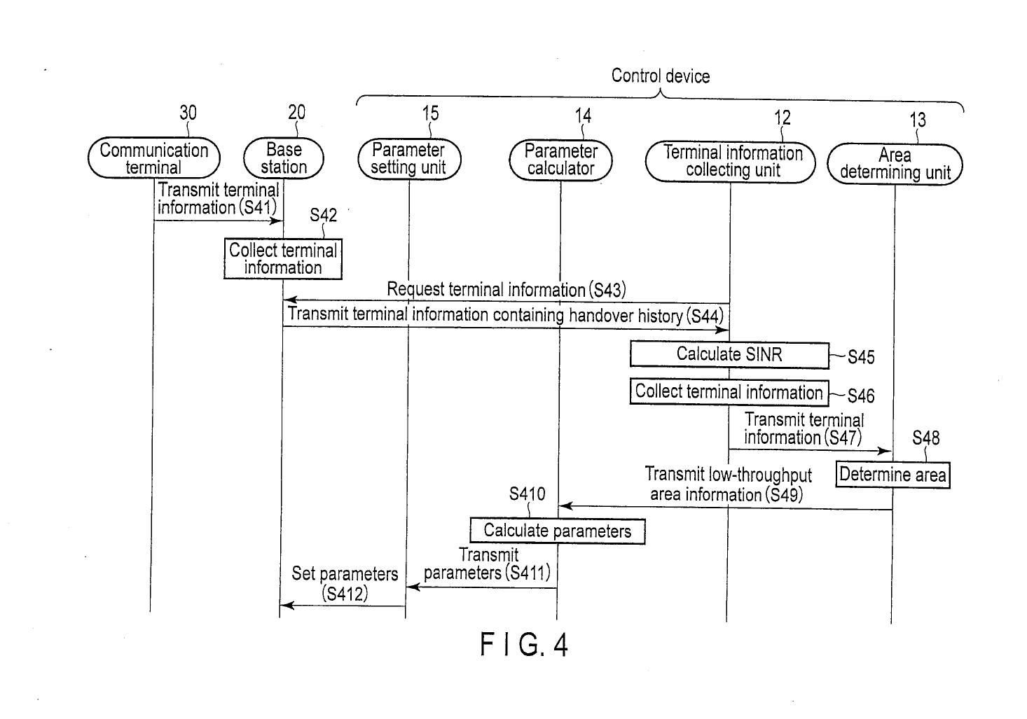

Next, the operation of the radio communication system with the above configuration when parameters of the base stations 20-1 to 20-3 are set is explained in detail. FIG. 4 is a sequence diagram showing a case wherein the radio communication system according to this embodiment sets parameters of the base stations 20-1 to 20-3.

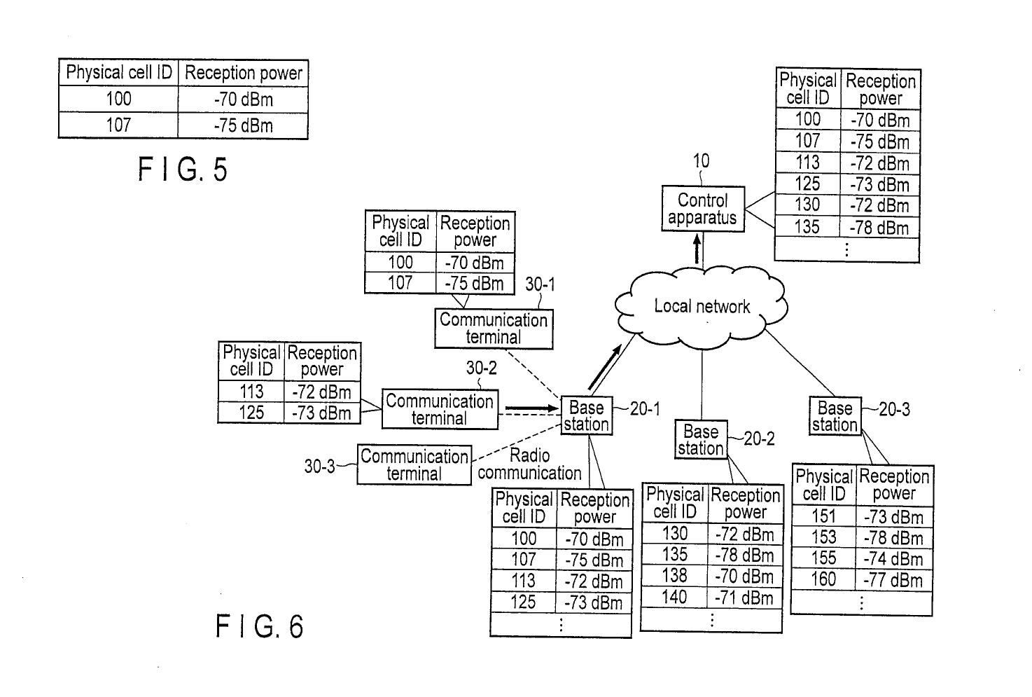

First, the communication terminals 30-1 to 30-3 each notify a correspondence table, which holds the reception power and physical cell ID therein as terminal information, and an identifier that can identify each terminal to the base station 20-1 (sequence S41). FIG. 5 is a diagram showing an example of a correspondence table contained in terminal information.

The base station 20-1 receives terminal information notified from the communication terminals 30-1 to 30-3 and collects the received terminal information (sequence S42).

The terminal information collecting unit 12 of the control apparatus 10 requests terminal information containing handover histories of the communication terminals 30-1 to 30-3 with respect to the base stations 20-1 to 20-3 at a preset timing (sequence S43). The base stations 20-1 to 20-3 notify the terminal information to the control apparatus 10 in response to the request from the control apparatus 10 (sequence S44).

The terminal information collecting unit 12 of the control apparatus 10 receives terminal information notified from the base stations 20-1 to 20-3 and calculates an SINR for each of the communication terminals 30-1 to 30-3 based on the reception power and physical cell ID contained in the received terminal information (sequence S45). FIG. 6 is a schematic diagram showing correspondence tables of the communication terminals 30-1, 30-2, base stations 20-1 to 20-3 and control apparatus 10. The terminal information collecting unit 12 collects terminal information items notified from the base stations 20-1 to 20-3 (sequence S46). The terminal information collecting unit 12 notifies the calculated SINR, reception power and handover history to the area determining unit 13 (sequence S47).

The area determining unit 13 refers to the SINR, reception power and handover history to determine a low-throughput area (sequence S48). The area determining unit 13 notifies low-throughput area information to the parameter calculator 14 (sequence S49). The parameter calculator 14 refers to the notified low-throughput area information to calculate parameters in the base stations 20-1 to 20-3 to enhance the throughput in the low-throughput area (sequence S410). The parameter calculator 14 notifies the calculated parameters to the parameter setting unit 15 (sequence S411). The parameter setting unit 15 sets the parameters notified from the parameter calculator 14 in the base stations 20-1 to 20-3 (sequence S412).

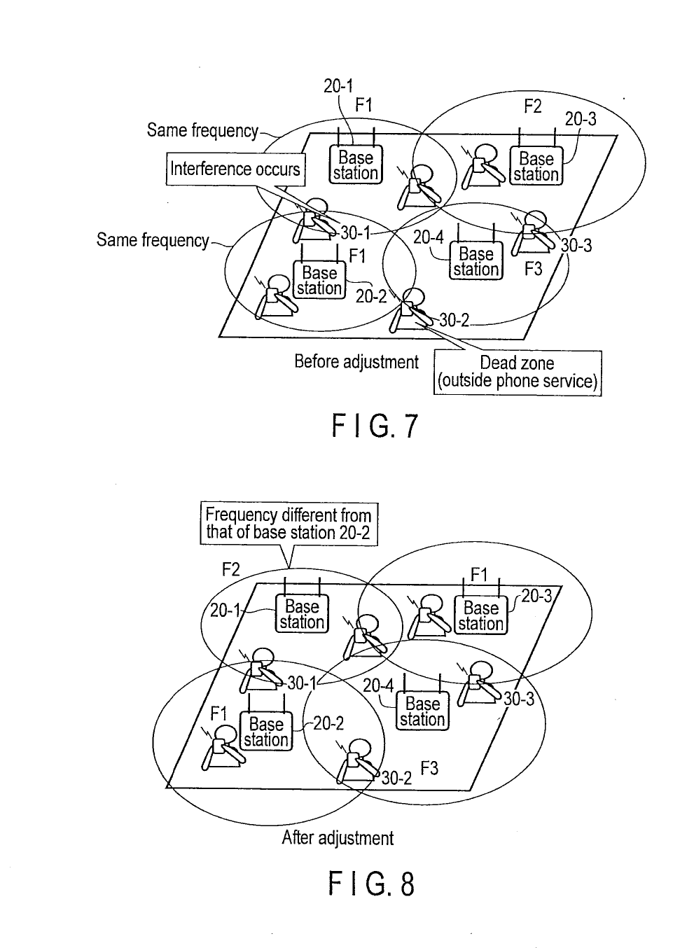

FIG. 7 is a schematic diagram showing an example of the state set before the control apparatus 10 adjusts the base stations 20-1 to 20-4. FIG. 8 is a schematic diagram showing an example of the state set after the control apparatus 10 adjusted the base stations 20-1 to 20-4.

In the case of FIG. 7, since a signal of frequency F1 transmitted from the base station 20-1 interferes with a signal of frequency F1 transmitted from the base station 20-2, sufficient throughput cannot be obtained in the communication terminal 30-1. Further, since the communication terminal 30-2 does not belong to a communication area formed by any one of the base stations, it is determined that the communication terminal 30-2 is positioned in the dead zone. Since the communication terminal 30-3 is present at a location near the very edge of a communication area formed by the base station 20-4, sufficient throughput cannot be obtained in the communication terminal 30-3.

On the other hand, as shown in FIG. 8, the control apparatus 10 sets the frequency of the base station 20-1 to F2 and sets the frequency of the base station 20-3 to F1. As a result, the throughput of the communication terminal 30-1 is enhanced. Further, the control apparatus 10 amplifies the transmission power of the base station 20-2 and transmission power of the base station 20-4. As a result, the dead zone in which the communication terminal 30-2 is present can be eliminated and the throughput of the communication terminal 30-3 is enhanced.

As described above, in the first embodiment, the base stations 20-1 to 20-3 receive reception power and the physical cell ID from the communication terminal 30 with which they make radio communications and output the received reception power and physical cell ID to the control apparatus 10 via the local network. The control apparatus 10 refers to the received reception power and physical cell ID to determine a low-throughput area and set parameters of the base stations 20-1 to 20-3 to enhance the throughput in this area. As a result, the radio communication system can dynamically enhance the throughput in the low-throughput area with reference to the reception power and physical cell ID acquired by the communication terminal 30.

Therefore, with the radio communication system according to the first embodiment, parameters can dynamically be adjusted to optimum values according to the radio wave environment during the operation.

Further, in the first embodiment, the base stations 20-1 to 20-3 each put their handover history into the terminal information and transmit the resultant information to the control apparatus 10. The control apparatus 10 determines a dead zone by referring to the handover history by the area determining unit 13 and calculates parameters for the base stations that cause a dead zone by the parameter calculator 14. Then, the control apparatus 10 sets the calculated parameters in the respective base stations by the parameter setting unit 15. As a result, the radio communication system can dynamically eliminate the dead zone.

In the first embodiment, a case wherein the terminal information collecting unit 12 collects all of the terminal information items transmitted from the base stations 20-1 to 20-3 is explained as an example, but the embodiment is not limited to this case. It is also possible for the terminal information collecting unit 12 to eliminate terminal information that does not satisfy a preset condition among the received terminal information items and collect only terminal information that satisfies the preset condition.

For example, the terminal information collecting unit 12 eliminates terminal information supplied from a communication terminal in which the SINR is larger than or equal to a preset threshold value. Then, the terminal information collecting unit 12 deals with terminal information supplied from a communication terminal in which the SINR is smaller than the threshold value as a to-be-processed object used in the following process. Further, the terminal information collecting unit 12 may refer to the handover history and eliminate terminal information supplied from a communication terminal that has failed in making a handover by less than a preset number of times in a preset closest period. At this time, the terminal information collecting unit 12 deals with terminal information supplied from a communication terminal that has failed in making a handover a preset times or more in the preset closest period as a to-be-processed object used in the following process. As a result, the processing amount in the area determining unit 13 will be reduced.

### Second Embodiment

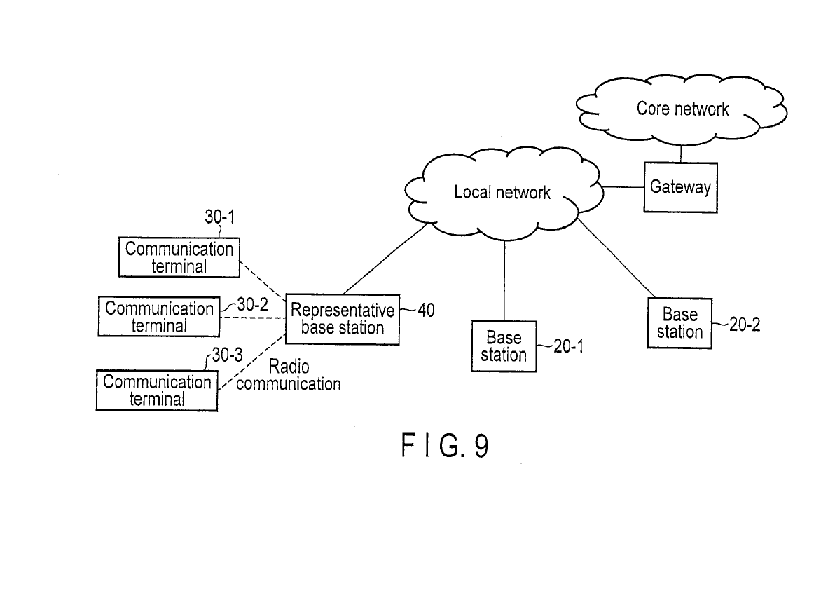

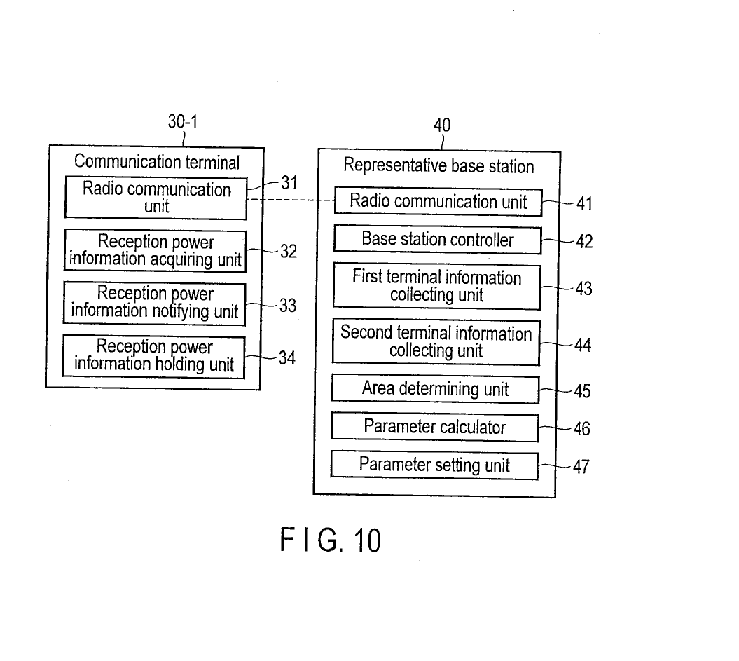

FIG. 9 is a block diagram showing the functional configuration of a radio communication system according to a second embodiment. The radio communication system shown in FIG. 9 includes a representative base station 40 and base stations 20-1, 20-2. The representative base station 40 and the base stations 20-1, 20-2 are connected via a local network. Referring to FIG. 9, the representative base station 40 accommodates communication terminals 30-1 to 30-3 for radio communication with it. Although not shown in FIG. 9, each of the base stations 20-1, 20-2 accommodates communication terminals for radio communication with it. The local network is connected to a core network (commercial network) via a gateway.

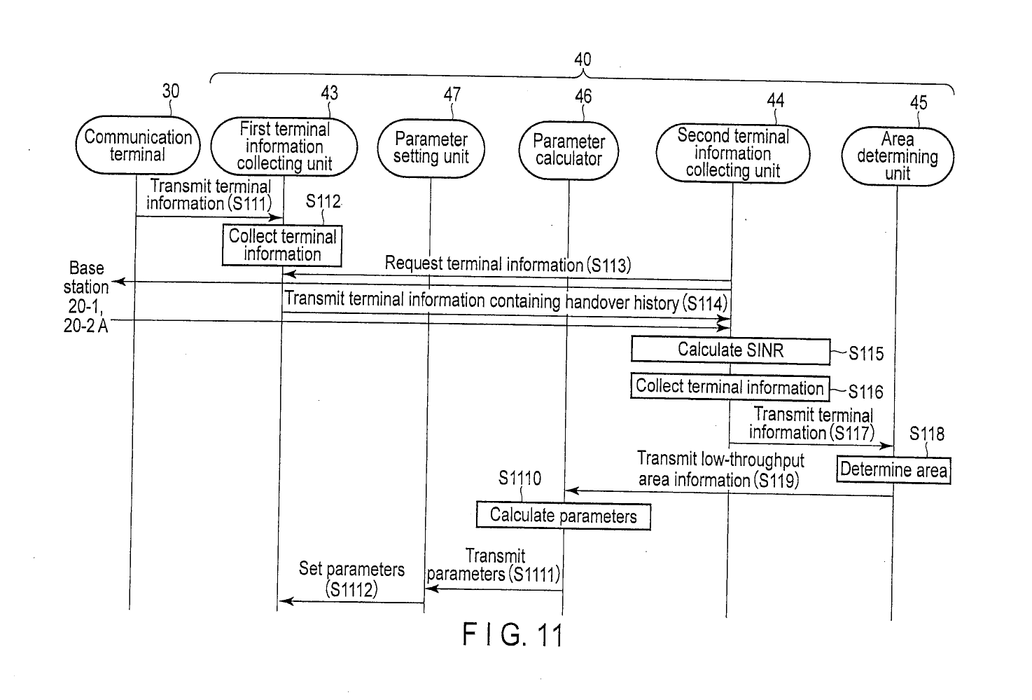

FIG. 10 is a block diagram showing the functional configuration of the representative base station 40 and communication terminal 30-1 shown in FIG. 9. The communication terminal 30-1 shown in FIG. 10 includes a radio communication unit 31, reception power information acquiring unit 32, reception power information holding unit 33, and reception power information notifying unit 34.

The radio communication unit 31 makes radio communication with the representative base station 40 based on an LTE protocol.

The reception power information acquiring unit 32 acquires reception powers of signals transmitted from the representative base station 40 and base stations 20-1, 20-2 and physical cell IDs used for specifying the base stations that have transmitted the signals on a preset cycle.

The reception power information holding unit 33 forms a correspondence table of the acquired reception power and physical cell ID, and holds the correspondence table. The reception power information holding unit 33 updates the correspondence table each time the reception power information acquiring unit 32 acquires a new reception power and physical cell ID.

The reception power information notifying unit 34 transmits the correspondence table as terminal information to the representative base station 40 in response to a request from the representative base station 40 connected thereto. At this time, the reception power information notifying unit 34 adds an identifier of its own terminal to the terminal information and transmits the resultant information to the representative base station 40. The reception power information notifying unit 34 may actively transmit terminal information to the representative base station 40 at a preset timing.

For example, the representative base station 40 shown in FIG. 10 includes a CPU, a storage area such as a ROM and RAM for programs and data used for permitting the CPU to perform processes and the like. The representative base station 40 includes a radio communication unit 41, base station controller 42, first terminal information collecting unit 43, second terminal information collecting unit 44, area determining unit 45, parameter calculator 46, and parameter setting unit 47. The functional configuration of the base stations 20-1, 20-2 shown in FIG. 10 is the same as that of the base station 20-1 shown in the first embodiment.

The radio communication unit 41 makes radio communications with the communication terminals 30-1 to 30-3. Further, the radio communication unit 41 monitors a handover of switching a connection to another base station by means of the communication terminals 30-1 to 30-3. The radio communication unit 41 forms a handover history that indicates whether the communication terminals 30-1 to 30-3 have succeeded or failed in making the handover.

The base station controller 42 controls the operations of the base stations 20-1 to 20-3.

The first terminal information collecting unit 43 receives terminal information transmitted from the communication terminals 30-1 to 30-3 and collects the received terminal information together with an identifier. In this case, the first terminal information collecting unit 43 may request terminal information items with respect to all of the communication terminals 30-1 to 30-3. Further, the first terminal information collecting unit 43 may request terminal information with respect to only to the communication terminal that is set in a connected state except the idle state. The first terminal information collecting unit 43 puts handover histories for the communication terminals 30-1 to 30-3 into the collected terminal information and outputs the resultant information to the second terminal information collecting unit 44.

The second terminal information collecting unit 44 receives terminal information output from the first terminal information collecting unit 43 and receives terminal information transmitted from the base stations 20-1, 20-2. The second terminal information collecting unit 44 refers to a correspondence table contained in the received terminal information to calculate the SINR for each communication terminal identified by the identifier. The second terminal information collecting unit 44 collects terminal information items supplied from the first terminal information collecting unit 43 and base stations 20-1, 20-2. The second terminal information collecting unit 44 outputs the calculated SINR and collected terminal information to the area determining unit 45.

The area determining unit 45 determines whether or not an area in which the communication terminal is present is a low-throughput area in which sufficient throughput cannot be ensured with reference to at least one of the SINR, reception power and handover history. The area determining unit 45 outputs the determination result to the parameter calculator 46. A system for determining the low-throughput area in the area determining unit 45 is the same as the system realized by use of the area determining unit 13 in the first embodiment.

The parameter calculator 46 determines parameters such as transmission power of its own station and/or base stations 20-1, 20-2, operation frequency, physical cell ID, neighbor list, handover threshold value, base station ID, frequency bandwidth, IP address of a base station, adjacent cell information, cell size and the like with reference to the determination result output from the area determining unit 45 to enhance the throughput in the low-throughput area. Specifically, for example, the parameter calculator 46 refers to the determination result to select at least one of its own station and base stations 20-1, 20-2 as a base station that causes a low-throughput area. The parameter calculator 46 calculates the transmission power and operation frequency for the selected base station to enhance the throughput in the low-throughput area. The parameter calculator 46 outputs the physical cell ID of the selected base station and the calculated transmission power and operation frequency to the parameter setting unit 47.

The parameter setting unit 47 sets parameters calculated by the parameter calculator 46 in its own station when the base station specified by the physical cell ID output from the parameter calculator 46 is its own station. Further, the parameter setting unit 47 sets parameters calculated by the parameter calculator 46 in the base station 20-1, 20-2 when the base station specified by the physical cell ID output from the parameter calculator 46 is the base station 20-1, 20-2, respectively.

Next, the operation when the radio communication system with the above configuration sets parameters of the representative base station 40 and base stations 20-1, 20-2 is explained in detail. FIG. 11 is a sequence diagram showing a case wherein the radio communication system according to this embodiment sets parameters in the representative base station 40 and base stations 20-1, 20-2.

First, the communication terminals 30-1 to 30-3 each notify a correspondence table, which holds the reception power and physical cell ID therein as terminal information, and an identifier that can identify each terminal to the representative base station 40 (sequence S111).

The first terminal information collecting unit 43 of the representative base station 40 receives terminal information notified from the communication terminals 30-1 to 30-3 and collects the received terminal information (sequence S112).

The second terminal information collecting unit 44 requests terminal information containing the handover history for the base stations 20-1, 20-2 at a preset timing (sequence S113). The base stations 20-1, 20-2 each notify the terminal information to the representative base station 40 in response to the request from the second terminal information collecting unit 44 (sequence S114).

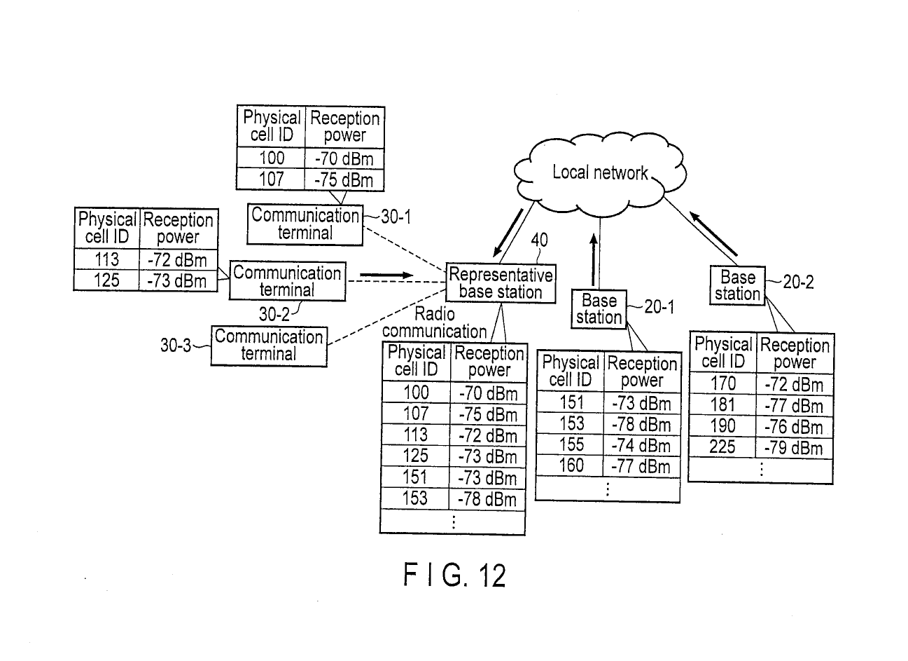

The second terminal information collecting unit 44 receives the terminal information notified from its own station and base stations 20-1, 20-2 and calculates SINRs for the respective communication terminals 30-1 to 30-3 based on the reception power and physical cell ID contained in the received terminal information (sequence S115). FIG. 12 is a schematic diagram showing a correspondence table in the communication terminals 30-1 to 30-3, representative base station 40 and base stations 20-1, 20-2. The second terminal information collecting unit 44 collects terminal information notified from the base stations 20-1, 20-2 (sequence S116). The second terminal information collecting unit 44 notifies the calculated SINR, reception power and handover history to the area determining unit 45 (sequence S117).

The area determining unit 45 refers to the SINR, reception power and handover history to determine a low-throughput area (sequence S118). The area determining unit 45 notifies low-throughput area information to the parameter calculator 46 (sequence S119). The parameter calculator 46 refers to the notified low-throughput area information to calculate parameters in its own station and base stations 20-1, 20-2 to enhance the throughput in the low-throughput area (sequence S1110). The parameter calculator 46 notifies the calculated parameters to the parameter setting unit 47 (sequence S1111). The parameter setting unit 47 sets the parameters notified from the parameter calculator 46 in its own station or base stations 20-1, 20-2 (sequence S1112).

As described above, in the second embodiment, the representative base station 40 receives the reception power and physical cell ID from the communication terminal 30 with which it makes radio communications and receives the reception power and physical cell ID from the base stations 20-1, 20-2. The representative base station 40 refers to the received reception power and physical cell ID to determine a low-throughput area and sets parameters of its own station and base stations 20-1, 20-2 to enhance the throughput in the area. As a result, the radio communication system can dynamically enhance the throughput in the low-throughput area with reference to the reception power and physical cell ID.

Therefore, with the radio communication system according to the second embodiment, parameters can dynamically be adjusted to optimum values according to the radio wave environment during the operation.

Further, in the second embodiment, the representative base station 40 determines a dead zone based on a handover history of the communication terminal contained in its own station and handover histories transmitted from the base stations 20-1, 20-2. Then, the representative base station 40 calculates parameters for the base stations that may cause a dead zone and sets the calculated parameters for the respective base stations. As a result, the radio communication system can dynamically eliminate the outside-range state.

In the second embodiment, a case wherein the second terminal information collecting unit 44 collects all of the terminal information items notified from the communication terminals communicating with and the terminal information items transmitted from the base stations 20-1, 20-2 is explained as an example, but the embodiment is not limited to this case. The second terminal information collecting unit 44 can eliminate terminal information that does not satisfy a preset condition among the received terminal information items and collect only terminal information that satisfies the preset condition.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus comprising:
a terminal information collecting unit configured to acquire reception powers and physical cell IDs from a plurality of base stations, calculate a Signal to Interference and Noise power Ratio (SINR) for each of a plurality of communication terminals that make radio communications with the plural base stations based on the acquired reception powers and physical cell IDs, and collect the acquired reception powers and physical cell IDs, wherein the reception powers are powers at which communication terminals receive a signal transmitted by each of the plural base stations, wherein the reception powers are transmitted from the communication terminal to a communicating base station, wherein the physical cell IDs are specifying base stations transmitting the signal, wherein the physical cell IDs are transmitted from the communication terminal to the communicating base station,
an area determining unit configured to determine a low-throughput area in which sufficient throughput is not obtained in reference to at least one of the SINRs and reception powers,
a parameter calculator configured to select a base station that causes the low-throughput area and calculate an operation frequency and transmission power of the selected base station to enhance the throughput of the low-throughput area, and
a parameter setting unit configured to set the calculated operation frequency and transmission power in the selected base station.

2. The control apparatus according to claim 1, wherein the terminal information collecting unit collects handover histories generated by the plural base stations, the handover history being generated based on whether the communication terminal successes or fails in making the handover, and
the area determining unit determines the low-throughput area based on the handover histories.

3. The control apparatus according to claim 1, wherein the terminal information collecting unit collects a reception power and physical cell ID supplied from the communication terminal in which the SINR is less than a preset threshold value among the acquired reception powers and physical cell IDs.

4. The control apparatus according to claim 2, wherein
the terminal information collecting unit collects a handover history, reception power and physical cell ID supplied from the communication terminal in which the SINR is less than a preset threshold value and/or the communication terminal that fails in making a handover by less than a preset number of times in a preset period.

5. A representative base station comprising:
a first terminal information collecting unit configured to acquire, from each of a plurality of communication terminals that make radio communication with its own station, a reception power at which the communication terminal receives a signal transmitted by each of a plurality of base stations and physical cell ID of the base station which transmits the signal, and collect the acquired reception powers and physical cell IDs,
a second terminal information collecting unit configured to acquire the reception powers and physical cell IDs collected by the first terminal information collecting unit and the reception powers and physical cell IDs collected by the plural base stations, calculate a Signal to Interference and Noise power Ratio (SINR) for each of the plural communication terminals based on the acquired reception powers and physical cell IDs, and collect the acquired reception powers and physical cell IDs,
an area determining unit configured to determine a low-throughput area in which sufficient throughput is not obtained in reference to at least one of the SINRs and reception powers,
a parameter calculator configured to select a base station that causes the low-throughput area and calculate an operation frequency and transmission power of the selected base station to enhance the throughput of the low-throughput area, and
a parameter setting unit configured to set the calculated operation frequency and transmission power in the selected base station.

6. The representative base station according to claim 5, wherein the second terminal information collecting unit collects handover histories generated by its own station and the plural base stations, the handover history being generated based on whether the communication terminal that makes radio communication with its own station or the plural base stations successes or fails in making a handover, and
the area determining unit determines the low-throughput area based on the handover histories.

7. The representative base station according to claim 5, wherein the second terminal information collecting unit collects a reception power and physical cell ID supplied from the communication terminal in which the SINR is less than a preset threshold value among the acquired reception powers and physical cell IDs.

8. The representative base station according to claim 6, wherein the second terminal information collecting unit collects a handover history, reception power and physical cell ID supplied from the communication terminal in which the SINR is less than a preset threshold value and/or the communication terminal that fails in making a handover by less than a preset number of times in a preset period.

9. A base station control method used for a radio communication system that includes a plurality of base stations that make radio communications with communication terminals, and acquire reception powers of signals transmitted from the plural base stations and physical cell IDs of the base stations that transmit the signals from the communication terminal that makes radio communications and a control apparatus that acquires the reception powers and physical cell IDs from the plural base stations and controls the plural base stations based on the acquired reception powers and physical cell IDs, comprising:
acquiring the reception powers and physical cell IDs from the plural base stations,
calculating a Signal to Interference and Noise power Ratio (SINR) for each of the plural communication terminals based on the acquired reception powers and physical cell IDs,
collecting the acquired reception powers and physical cell IDs,
determining a low-throughput area in which sufficient throughput is not obtained in reference to at least one of the SINRs and reception powers,
selecting a base station that causes the low-throughput area,
calculating an operation frequency and transmission power of the selected base station to enhance the throughput of the low-throughput area, and
setting the calculated operation frequency and transmission power with respect to the selected base station.
